(19) United States
(12) Patent Application Publication
(10) Pub. No.: US 2008/0043352 A1
(43) Pub. Date: Feb. 21, 2008

(54) Lightweight mirrors and methods of manufacturing lightweight mirrors

(76) Inventor: Tong Liu, Plano, TX (US)

Correspondence Address: MICHAEL A. O'NEIL, P.C., 5949 SHERRY LANE, SUITE 820, DALLAS, TX, 75225, US

(21) Appl. No.: 11/788,463

(22) Filed: Apr. 20, 2007

(30) Foreign Application Priority Data
Jun. 20, 2006 (CN) 200610093068.4
Jun. 20, 2006 (CN) 200610096068.4

(51) Int. Cl. G02B 7/192

(52) U.S. Cl. 359/848

(57) ABSTRACT

A lightweight mirror comprises a plurality of plates including an optical plate, a backing plate, spacer plates, and, if needed, one or more reinforcing plates. The plates are joined to one another thereby forming a unitary structure. The unitary structure comprising the plates is then formed into a predetermined optical mirror configuration.

### CROSS-REFERENCE TO RELATED APPLICATION

This application claims priority of Chinese patent application number 200610093068.4 filed Jun. 20, 2006, currently pending, the entire contents of which are incorporated herein by reference.

### TECHNICAL FIELD, BACKGROUND, AND SUMMARY OF THE INVENTION

1. Field of the Invention

This invention relates to lightweight mirrors comprising an optical plate, a backing plate, one or more intermediate reinforcing plates (as required) and a plurality of spacer plates, all manufactured from the same material as the optical plate. All of the components can be manufactured from commercially available plate materials at very low cost and at volume efficiencies, yet deliver high quality optics. The exact number of spacer plates and the location of the spacer plates can be optimized using the Finite Element Method based on the deformation requirements of the mirror

2. Discussion of the Prior Art

Telescope mirrors are required to resist deformation from gravitational loads. Deformation changes the shape of the mirror, and as a result, degrades the reflected images. Conventional mirrors achieve high rigidity by constructing the mirrors from thick solid glass disks. Typical glass thicknesses range from about one tenth to about one sixth the mirror diameter. As a result, conventional mirrors are heavy and are expensive to manufacture due to high material costs. In addition, the thickness of the glass used in conventional mirrors requires expensive annealing steps to eliminate internal stresses from the glass.

Lightweight telescope mirrors typically have an optical plate, a supporting core, and a backing plate. The outer structural plates are the optical plate and the backing plate which are separated by the core. Quartz glass, fused quartz, high-silica glass, etc. are typical materials used for the core, the optical plate, and the backing plate. Representative of the prior art are U.S. Pat. No. 5,076,700 to DeCaprio and U.S. Pat. No. 4,447,130 to Christiansen.

The core of a lightweight telescope mirror is conventionally a honeycomb or other closed cell-type structure. A honeycomb core is fabricated by hand-welding individual ribs made from short sections of tubing. These manufacturing methods are expensive and present significant risk of damaging the core during the manufacturing process.

U.S. Pat. No. 2,988,959 discloses a lightweight mirror blank for astronomical purposes comprising an optical plate and a backing plate separated by a supporting framework comprising a plurality of rows of tubes, the tube rows being arranged in a staggered relationship to one another. The tube axes are parallel to one another and parallel to the mirror axis. Glass is the material used to fabricate the lightweight mirror blank. The individual tubes are permanently joined to the optical plate and to the backing plate by means of cement. The tubes typically have a circular, or rectangular, or triangular cross section.

GB Pat. No. 1,167,895 discloses lightweight mirrors wherein the optical plate and the backing plate are joined by a core that consists either of tubing sections or of spacing members of cruciform cross section. Instead of the tubing sections or spacers of cruciform cross section, spacers can also be used which consist of interlocking strips arranged in a kind of “egg crate” configuration.

Another lightweight mirror blank for astronomical purposes is disclosed in British Pat. No. 968,025, which has an optical plate and a backing plate as well as a supporting framework permanently joined to the two plates and made of tubes of hexagonal cross section assembled in a honeycomb configuration. Transparent vitreous silica, opaque vitreous silica, or a glass of high silica content is the material used in construction of the lightweight mirror blanks described therein.

U.S. Pat. No. 3,507,737 discloses a lightweight mirror blank which has a supporting framework comprising a plurality of slotted, elongated, flat spacing member fitted together in an “egg crate” configuration.

U.S. Pat. No. 3,644,022 discloses lightweight mirrors in which the core is formed of Y-shaped components that are welded together to form a honeycomb-like core framework of high rigidity. A silicon dioxide-containing material is used in the fabrication of the mirrors. A major shortcoming of this type of construction is that it is relatively high in cost due to difficulty in the manufacture of the support structure.

U.S. Pat. No. 3,754,812 discloses a method of fusing an optical plate and a backing plate to a core. Fusing is achieved by high intensity radiant heat from a high temperature carbon arc. The glass must reach the fusing temperature. At this temperature the optical plate, backing plate, and core are susceptible to sagging and require support. Closed cell core designs do not facilitate installing supports and removing the supports after fusing of the optical plate and the backing plate to the core. In the prior art removal of the supports requires the presence of holes in the backing plate as described by Christiansen, U.S. Pat. No. 4,331,383. The supports are removed through these holes. Supports can also be removed by disassembly or destruction of the supports.

U.S. Pat. No. 6,176,588 discloses a method of bonding an extruded ceramic honeycomb core to an optical plate in a predetermined configuration. An optional backing plate may be bonded or attached to the backing plate of the core to improve the mechanical stability and stiffness of the mirror blank.

It is very difficult and expensive to make a large mirror. Therefore, several smaller segmented sections can be used to make one large mirror. For a regular segmented mirror, each segment is ground, polished, and configured individually. All segments must be configured, so that all of the parts comprise the same overall parent shape. This requires a non-traditional, and therefore very difficult and expensive, configuring procedure to create the off-axis, or non-cylindrically symmetric surfaces of the segments. Once installed in the telescope the segments must be positioned precisely, using a very complicated and expensive mechanism, on the parent shape and maintain the optimal shape in spite of changing the pointing (gravity) direction, thermal effects, and wind disturbances.

In the known lightweight mirror blanks the optical and backing plates are always a single piece. However, a single large plate may not be available, or too expensive to use in making a large mirror.

In the known lightweight mirror blanks neither intermediate reinforcing plates nor round supporting spacers have been used.

In the known lightweight mirror blanks all required precision fabrication procedures for the core support element are time consuming and relatively expensive.

All these shortcomings have been addressed and overcome by the present invention.

### SUMMARY OF THE INVENTION

In accordance with the invention a new and improved lightweight telescope mirror design and method of constructing a lightweight telescope mirror are provided. The lightweight telescope mirror of the invention is comprised of an optical plate, one or more intermediate reinforcing plates (as required), a backing plate, and small solid round, triangular, or square spacer plates positioned between the plates. The optical plate, the intermediate reinforcing plates (if used), the backing plate, and the spacer plates can be constructed of commercially available flat plate glass or glass-like materials. Identical spacer plates can be easily constructed from readily available plate materials. The spacer plates are positioned between and joined by welding or fusing to opposing faces of the plates.

One of the key improvements is the addition of the intermediate reinforcing plates which enables the usage of the same thin plate material for all of the plates and spacer plates regardless of the size of the final mirror blank. In order to obtain the best thermal properties it is extremely, critical to use thin plate materials throughout the mirror.

Another key improvement is the use of the dimensionally small round (or other suitable shape) supporting spacer plates which greatly increase the stiffness of the mirror as compared with traditional long supporting structures while simultaneously greatly reducing the complexity and cost of the fabrication of the mirror.

The improved mirror may have any required mirror surface shape (convex, concave, or flat), any suitable exterior shape, for example, circular, elliptical or rectangular, and may be of any desired size, varying from a few inches to several meters in diameter. Flat plates and flat spacer plates are first glued together, then slumped and fused to the desired convex, concave, or flat shape. All spacer plates in different layers must be aligned vertically parallel to the optical axis before the slumping and fusing process. The spacer plates can be one on top of another to provide higher support structure, or to reduce the number of intermediate reinforcing layers depending upon the requirements of particular embodiments of the invention.

The use of plate material of the same thickness is recommended for all plates and spacer plates in the same mirror, but it is not a requirement. As opposed to all previous lightweight mirrors, mirrors comprising the present invention are completely scaleable in the sense that the same plate material of the same thickness can be used for mirrors of all sizes. This extremely simplifies the construction process of the mirror and significantly reduces production costs.

The adjacent plates are bonded to the spacer plates that support them in an appropriate spacing distribution. The spacer plates normally (but not necessarily) have the same thickness as the optical, reinforcing, and backing plates. When the mirror has a length L, then the number of layers of plates and spacer plates should be such that the mirror will have a length to over all thickness ratio of between about 4 to 1 and about 10 to 1. The spacer plates can be one on top of another to provide higher support structure, or to reduce the number of intermediate reinforcing layers depending upon the requirements of particular embodiments of the invention.

The solid spacer plates can have various cross sectional shapes, such as circular, square, or triangular. The cross sectional dimension should be approximately same as the plate thickness. The distance between adjacent spacers should be between about 2 times and about 10 times the plate thickness, and the spacer plates are arranged in such a way as to provide the maximum of support of the plates while contributing minimum weight.

Another key improvement is that all of the plates can be segmented. Although other shapes are also possible, the simplest segmentation scheme is single ring of identical petals. The plates are positioned angularly relative to each other to provide support for adjacent plates thereby maximizing the structured integrity of the mirror.

### BRIEF DESCRIPTION OF THE DRAWINGS

FIG. 1 is a plan view for a circular mirror, with parts removed, comprising the invention;

FIG. 2 is the sectional view taken at 2-2 of FIG. 1;

FIG. 3 is a perspective illustration of a circular spacer plate used in FIGS. 1 and 2;

FIGS. 4 and 5 are the illustrations of the slumping and fusing process of the concave mirror blank described in FIGS. 1, 2 and 3;

FIG. 6 is a perspective view of a flat mirror blank having 3 plates; each plate being segmented into 3 identical petals;

FIG. 7 is an illustration of the optical plate of the embodiment described in FIG. 6;

FIG. 8 is the intermediate reinforcing plate of the embodiment described in FIG. 6;

FIG. 9 is an illustration of the backing plate of the embodiment described in FIG. 6;

FIG. 10 is a sectional view taken at 2-2 of FIG. 1, but made in a different way, where all plates are fused flatly, and the optical plate is thicker than the other plates;

FIG. 11 is an illustration of a curved mirror produced from the mirror blank described in FIG. 10;

FIG. 12 is an illustration of an early step of a third production process comprising the invention;

FIG. 13 is an illustration of a later step in the third production process; and

FIG. 14 is an illustration of a concluding step in the third production process.

### DETAILED DESCRIPTION

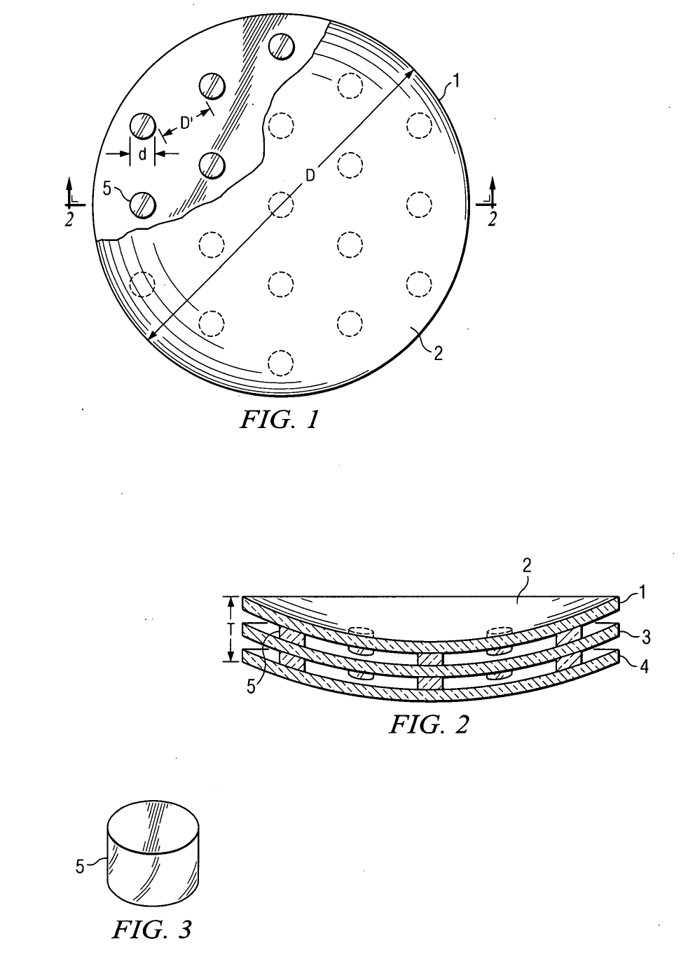

FIG. 1 is a plan view for a circular mirror, with parts removed, comprising the present invention, and FIG. 2 is the sectional view taken along the line 2-2 of FIG. 1. The improved mirror illustrated in FIG. 1 is of circular shape comprising an optical plate 1 having a convex mirror surface 2, a backing plate 4, and an intermediate reinforcing plate 3. The plates 1, 3, and 4 secured to each other by a plurality of spacer plates 5. The spacer plates 5 have diameters d and are separated one from another by distances D′. The number of intermediate reinforcing plates is determined by assuring that the maximum over-all thickness T of the mirror with respect to the diameter D is such that ratio of D to T is in the range of between about 10 to 1 and about 4 to 1, most advantageously in the range of about 6 to 1.

The embodiment described in FIG. 6 is a mirror blank comprising 3 plates; each plate being segmented into three identical petals. The top plate is the optical plate, which is segmented into 3 identical petals 8, 9 and 10.

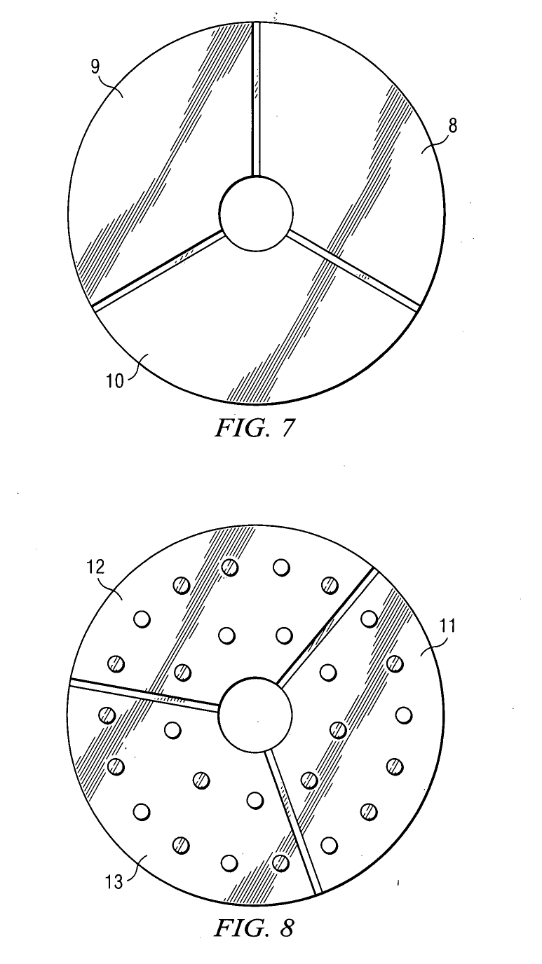

FIG. 7 is the top view of the embodiment described in FIG. 6.

FIG. 8 is the top view of the intermediate reinforcing plate of the embodiment described in FIG. 6 (with the top plate removed). The intermediate reinforcing plate is segmented into 3 identical petals 11, 12 and 13.

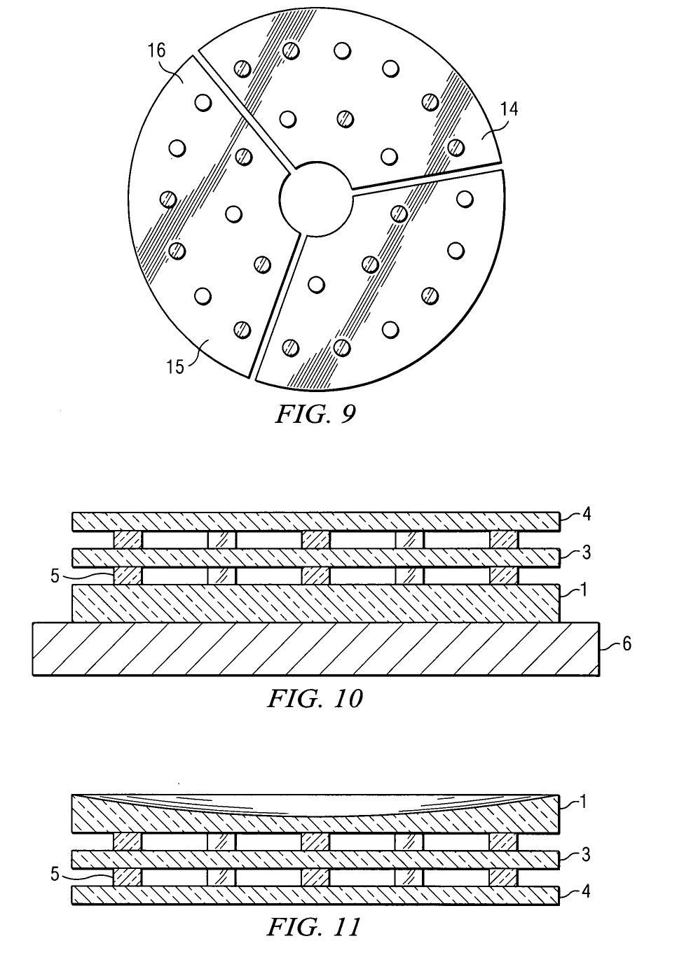

FIG. 9 is the top view of the backing plate of embodiment described in FIG. 6 with both the optical plate and the intermediate reinforcing plate removed. The backing plate is segmented into 3 identical petals 14, 15 and 16.

The intermediate reinforcing plate is turned 40° around the optical axis relative to the optical plate. The backing plate is turned 80° around the optical axis relative to the optical plate.

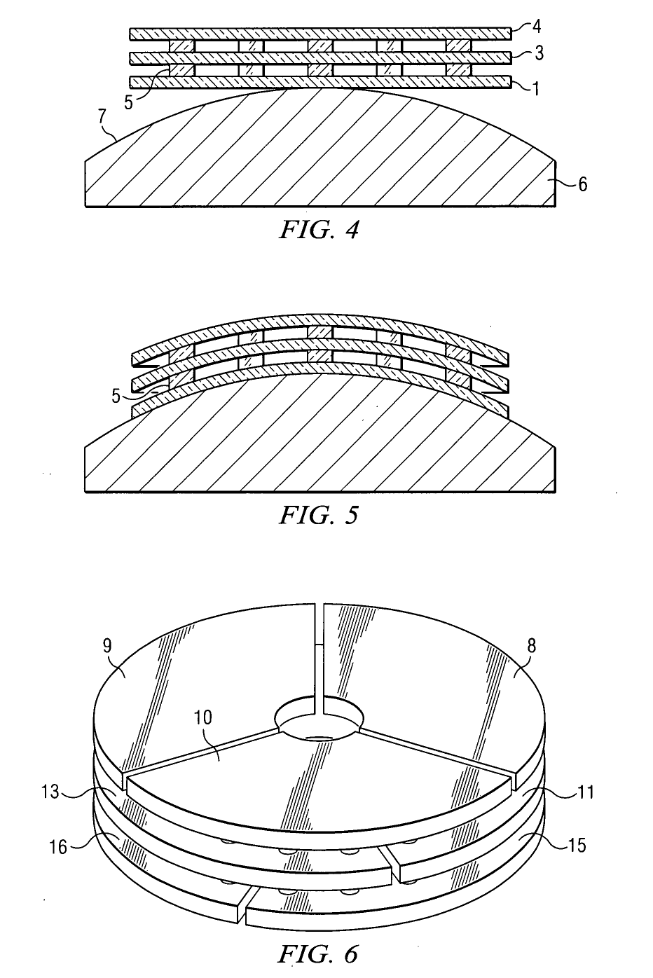

A first production process is described in the following subparagraphs, and part of the process is illustrated in FIG. 4 and FIG. 5.

a) Make a master mold 6 with the inverse shape 7 of the mirror's optical surface 2.

b) Assemble the mirror blank and secure the component parts together. All spacer plates in different layers must be aligned vertically with the axes thereof extending parallel to the optical axis before slumping and fusing.

c) Lay the mirror blank evenly on top of the mold, with the intended optical mirror surface facing down on the inverse shape of mold 6.

d) Slump the assembled mirror blank to the master mold 6 in an oven.

e) Continue to fuse the assembled mirror blank to assure that all parts are fused together and then start the cooling and annealing process.

f) Release the mirror blank from the mold 6 and it will be ready for further processing.

A second production process for a concave mirror is described in the following subparagraphs, and part of the process is illustrated in FIG. 10 and FIG. 11.

a) Make a master mold 6 with flat surface.

b) Assemble the mirror blank and secure the component parts together. All spacer plates in different layers must be aligned vertically with their, axes extending parallel to the optical axis before slumping and fusing.

c) Lay the mirror blank evenly on top of the mold, with the intended optical mirror surface facing down to the mold 6.

d) Fuse the assembled mirror blank to make assure that all parts are fused together and then start the cooling and annealing process.

e) Release the mirror blank from the mold 6, grind the optical plate to the required curve, and it is ready for further processing.

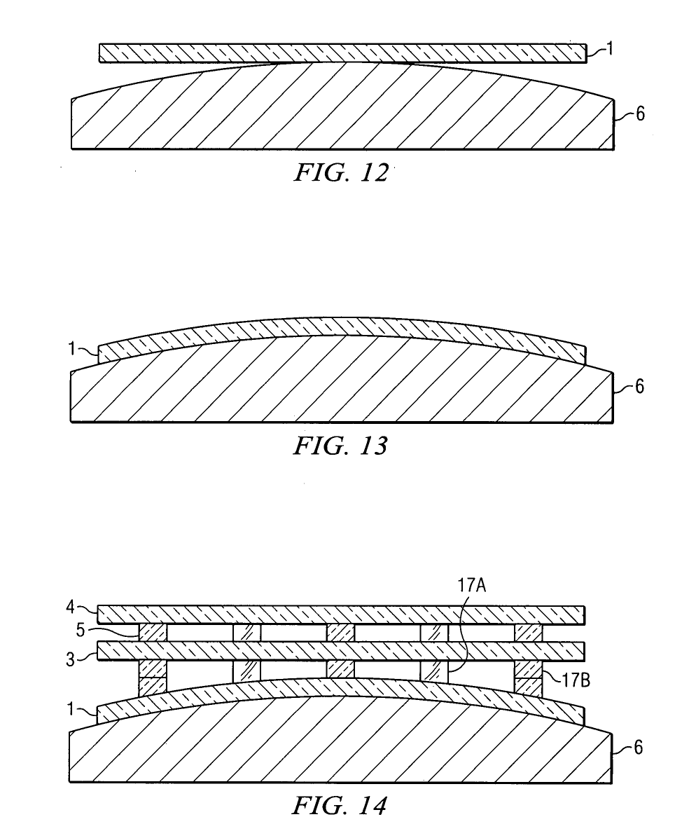

A third production process for a concave mirror is described in the following subparagraphs, and part of the process is illustrated in FIG. 12, FIG. 13, and FIG. 14.

a) Make a master mold 6 with the inverse shape 7 of the mirror's optical surface 2.

b) Lay the optical plate evenly on top of the mold, with the intended optical mirror surface facing down to the inverse shape of mold 6.

c) Slump the optical plate to the master mold 6 in an oven.

d) Assemble the curved optical plate, the curved spacer 17A, and stacked curved spacer plates 17B between the optical plate and the support plate and the flat spacer 5 between the flat support plate and the back plate. All spacer plates in the different layers must be aligned vertically and parallel to the optical axis before slumping and fusing.

e) Lay the assembled mirror blank evenly on top of the mold, with the optical mirror surface facing down to the inverse shape of mold 6.

f) Fuse the assembled mirror blank to make sure all parts are fused together and then start the cooling and annealing process.

g) Release the mirror blank from the mold 6 and it is ready for further processing.

The foregoing descriptions of the exemplary embodiments of the invention have been presented for the purposes of illustration and description. It is not intended to be exhaustive or to limit the invention to the precise forms disclosed. Many modifications and variations are possible in light of the above teaching. It is intended that the scope of the invention be limited not by the foregoing detailed description, but rather by the claims appended hereto.

In particular, as will be understood by those skilled in the art, the actual arrangement and the number of spacer plates, the number of the plates, the shape of the segmentation, and the overlapping scheme of the segmented plates in the mirror blank assembly is not limited to the detailed description, but rather by the claims appended hereto.

Also, as will be understood by those skilled in the art, the details of the slumping and fusing processing of the assembled mirror blank are not important to the inventive features of the present invention.

1. A lightweight mirror blank comprising:
an optical plate formed from a material selected from the group consisting of fused silica, quartz glass and high-silica glass;
a backing plate formed from the same material as the optical plate;
a plurality of spacer plates formed from the same material as the optical plate and the backing plate;
the spacer plates being positioned at predetermined locations between and in engagement with the optical plate and the backing plate;
the optical plate, the spacer plates, and the backing plate being joined one to another by a process selected from the group consisting of gluing, welding, and fusing whereby the optical plate, the spacer plates, and the backing plate comprise a unitary structure.

2. The lightweight mirror according to claim 1 further including at least one reinforcing plate positioned between the optical plate and the backing plate.

3. The lightweight mirror according to claim 1 wherein the optical plate, the backing plate, and the spacer plates are further characterized by substantial equal thicknesses.

4. The lightweight mirror according to claim 1 wherein the optical plate and the backing plate are further characterized by substantially equal thicknesses and wherein the spacer plates are further characterized by thicknesses that are between 0.5 times and 3 times of the thicknesses of the optical plates and the backing plate.

5. The lightweight mirror according to claim 1 wherein each of the spacer plates is characterized by a major width dimension which is between about equal to and about twice the thickness thereof.

6. The lightweight mirror according to claim 1 wherein the distance between adjacent spacer plates is between about two times and about ten times the thickness of the optical plate.

7. The lightweight mirror according to claim 1 wherein the optical plate and the backing plate each comprise segmented plates, and wherein the segments comprising the optical plate and the backing are oriented relative to each other to maximize structural rigidity of the astronomical mirror.

8. A method of manufacturing lightweight mirrors comprising the steps of:
providing an optical plate formed from a material selected from the group consisting of fused silica, quartz glass and high-silica glass;
providing a backing plate formed from the same material as the optical plate;
providing a plurality of spacer plates formed from the same material as the optical plate and the backing plate;
positioning the spacer plates in a spaced apart array and in engagement with the optical plate and the backing plate;
joining the optical plate, the spacer plates, and the backing plate one to another by a process selected from the group consisting of gluing, welding, and fusing whereby the optical plate, the spacer plates, and the backing plate comprising an unitary structure;
thereafter forming the unitary structure comprising the optical plate, the spacer plates, and the backing plate into a predetermined mirror configuration.

9. The method of manufacturing lightweight mirrors according to claim 8 including the additional steps of:
providing a reinforcing plate;
positioning the reinforcing plate between the optical plate and the backing plate;
positioning spacer plates comprising a predetermined percentage of the plurality of spacers between the backing plate and the reinforcing plate;
positioning the remainder of the spacer plates comprising the plurality of spacer plates between the reinforcing plate and the optical plate; and
joining the optical plate, the spacer plates positioned between the optical plate and the reinforcing plate, the reinforcing plate, the spacer plates positioned between the reinforcing plate and the backing plate, and the backing plate into a unitary structure.

10. The method of manufacturing lightweight mirrors according to claim 9 including the additional step of forming the unitary structure comprising the optical plate, the reinforcing plate, the backing plate, and the spacer plates into a predetermined optical mirror configuration.

11. The method of manufacturing lightweight mirrors according to claim 8 further characterized by providing an optical plate, a backing plate, and a plurality of spacer plates which are substantially equal in thickness.

12. The method of manufacturing lightweight mirrors according to claim 8 further characterized by providing an optical plate and a backing plate which are substantially equal in thickness and by providing a plurality of spacer plates having thicknesses which are between 0.5 times and 3 times of the thicknesses of the optical plate and the backing plate.

13. The method of manufacturing lightweight mirrors according to claim 8 further characterized by providing a plurality of spacer plates each characterized by a major width dimension which is between about equal to and about twice the thickness thereof.

14. The method of manufacturing lightweight mirrors according to claim 8 further characterized by the step of positioning the spacer plates at locations wherein the distances between adjacent spacer plates is between about two times and about ten times the thickness of the optical plate.

15. The method of manufacturing lightweight mirrors according to claim 8 including the additional step of:
providing an optical plate comprising a plurality of segmented plates;
providing a backing plate comprising a plurality of segmented plates; and
orienting the segmented optical plate and the segmented backing plate relative to each other in a manner that maximizes the structural rigidity of the lightweight astronomical mirror.
